(19) United States
(12) Patent Application Publication
(10) Pub. No.: US 2025/0092996 A1
(43) Pub. Date: Mar. 20, 2025

(54) METHOD FOR MANUFACTURING HIGH PRESSURE TANK

(71) Applicant: HONDA MOTOR CO., LTD., Tokyo (JP)

(72) Inventors: Masanori HORI, Wako-shi (JP); Kosuke TATSUSHIMA, Wako-shi (JP)

(21) Appl. No.: 18/882,075

(22) Filed: Sep. 11, 2024

(30) Foreign Application Priority Data
Sep. 20, 2023 (JP) 2023-152033

(51) Int. Cl. F17C 1/06

(52) U.S. Cl. CPC F17C 1/06; F17C 2203/0604; F17C 2203/0663

(57) ABSTRACT

The present invention provides a method for manufacturing a high pressure tank having a reinforcing layer on an outer surface of a liner provided with dome portions at both end portions of a round tubular shaped body portion, the method including: a winding process of winding a fiber bundle containing a curable resin and having a predetermined tension on the outer surface of the liner; and a reinforcing layer forming process of forming the reinforcing layer by curing the curable resin contained in the fiber bundle wound around the outer surface, in which the winding process is performed so that the tensions of the fiber bundles at the both end portions are lower than a tension of the fiber bundle at a general portion of the body portion defined between the both end portions.

### BACKGROUND OF THE INVENTION

### Field of the Invention

The present invention relates to a method for manufacturing a high pressure tank.

### Description of the Related Art

In the related art, a high pressure tank having a reinforcing layer on an outer circumference of a round tubular shaped body portion of a liner is known (for example, see Patent Literature 1).

The method for manufacturing this high pressure tank includes a process of forming a first reinforcing layer on an outer circumference of a body portion of a liner by a hoop winding of a tow prepreg (a fiber bundle containing a curable resin); a process of forming a second reinforcing layer on the first reinforcing layer by a helical winding od the tow prepreg; and a process of curing a curable resin contained in the tow prepreg.

### PRIOR ART DOCUMENT(S)

### Patent Literature(s)

Patent Literature 1: JP2023-073617A

However, in a prior art method for manufacturing a high pressure tank (for example, see Patent Literature 1), when the fiber bundle is wound and overlapped on the entire body portion along the axial direction of the body portion of the liner, the winding of the fiber bundle may be collapsed at both end portions of the body portion. When the winding of the fiber bundle is collapsed, the breaking strength of the reinforcing layer may be reduced.

An object of the present invention is to provide a method for manufacturing a high pressure tank which more reliably increases the breaking strength of a reinforcing layer as compared with the conventional art.

### SUMMARY OF THE INVENTION

In order to achieve the object, the present invention provides a method for manufacturing a high pressure tank having a reinforcing layer on an outer surface of a liner provided with dome portions at both end portions of a round tubular shaped body portion, the method including: a winding process of winding a fiber bundle containing a curable resin and having a predetermined tension on the outer surface of the liner; and a reinforcing layer forming process of forming the reinforcing layer by curing the curable resin contained in the fiber bundle wound around the outer surface, in which the winding process is performed so that the tensions of the fiber bundles at the both end portions are lower than a tension of the fiber bundle at a general portion of the body portion defined between the both end portions.

According to the method for manufacturing a high pressure tank of the present invention, the breaking strength of the reinforcing layer can be more reliably increased than in the related art.

### BRIEF DESCRIPTION OF THE DRAWINGS

FIG. 1 is a longitudinal section view of a high pressure tank obtained by a method according to an embodiment of the present invention.

FIG. 2 is a partial enlarged side view of the high pressure tank obtained by the method according to the embodiment of the present invention.

FIG. 3 is a configuration diagram of the high pressure tank manufacturing equipment used in the method according to the embodiment of the present invention.

FIG. 4 is an explanatory diagram of a hoop winding of the fiber bundle performed in the method according to the embodiment of the present invention.

FIG. 5 is an explanatory diagram of a fiber bundle winding process performed in the method according to the embodiment of the present invention.

FIG. 6 is an explanatory diagram of a high helical winding of the fiber bundle performed in the method according to the embodiment of the present invention.

FIG. 7 is an explanatory diagram of a low helical winding of the fiber bundle performed in the method according to the embodiment of the present invention.

### DESCRIPTION OF THE INVENTION

Next, an embodiment for carrying out the present invention will be described in detail with reference to the drawings as appropriate. First, a structure of the high pressure tank obtained by the method according to this embodiment will be described.

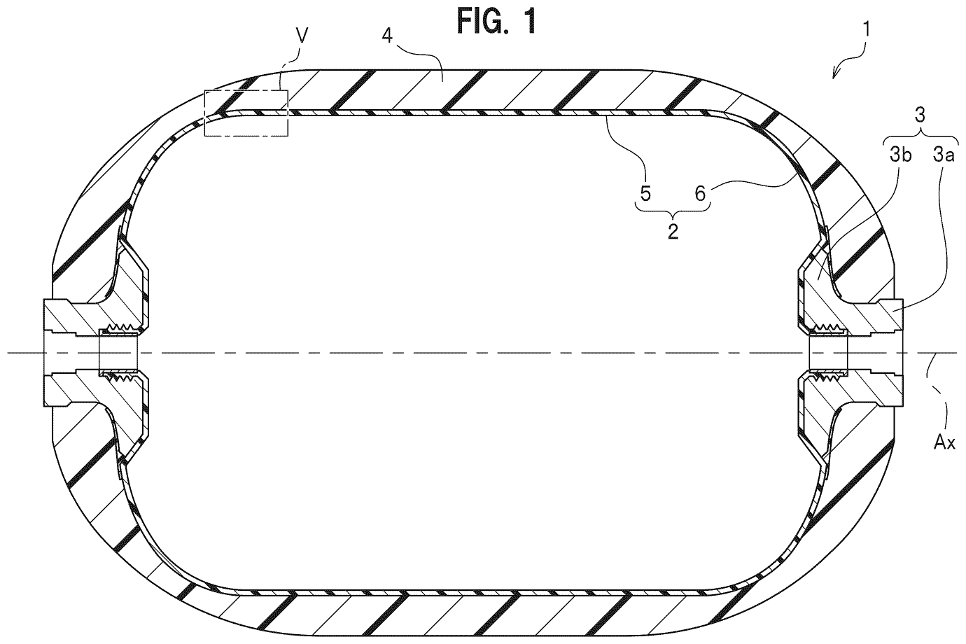

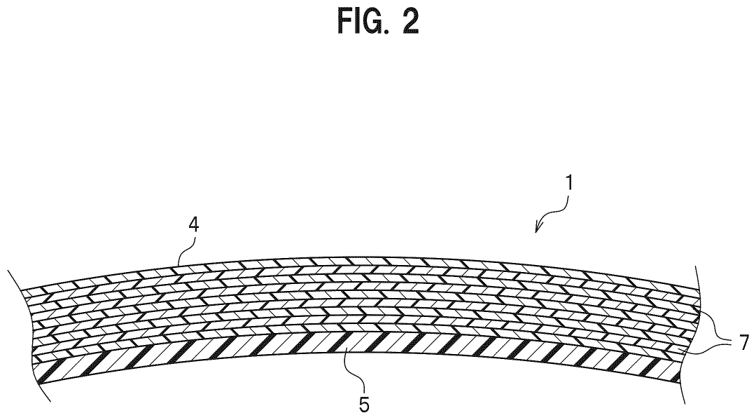

FIG. 1 is the longitudinal section view of the high pressure tank 1. FIG. 2 is the partial enlarged side view of the high pressure tank 1.

For example, the high pressure tank 1 of this embodiment is a high pressure tank that is mounted on a fuel cell vehicle and stores hydrogen gas to be supplied to a fuel cell system. However, the high pressure tank 1 is not limited to this. The high pressure tank 1 may be a high pressure tank used for another high pressure gas.

As shown in FIG. 1, a high pressure tank 1 includes a liner 2, a mouthpiece 3 connected to the liner 2, and a reinforcing layer 4 covering the outside of the mouthpiece 3 from the liner 2.

For example, the mouthpiece 3 is formed of a metal material such as aluminum alloy. The mouthpiece 3 includes a cylindrical mouthpiece body 3a having a feed/discharge hole therein and a flange portion 3a formed at one end of the mouthpiece body 3b in the axial direction.

The liner 2 is a hollow body made of thermoplastic resin. For example, the thermoplastic resin may be a polyamide resin, a polyethylene resin, or the like, but is not limited thereto.

The liner 2 of this embodiment includes a round tubular shaped body portion 5 and dome portions 6 integrally formed at both ends of the body portion 5.

As shown in FIG. 1, the dome portion 6 is a flat bowl-shaped body which is gradually reduced in diameter as it goes away from the body portion 5 side to the outside in the Ax-axis direction.

The radial central portion of the dome portion 6 is recessed to correspond to the shape of the flange portion 3b of the mouthpiece 3.

As shown in FIG. 1, the reinforcing layer 4 is formed from the outer surface of the liner 2 to the outer surface of the mouthpiece 3.

As will be explained in detail later, the reinforcing layer 4 is formed by curing a curable resin contained in a tow prepreg wound around the mouthpiece 3 from the liner 2.

The tow prepreg of this embodiment is formed of a fiber bundle (tow) of a reinforcing fiber containing the curable resin, and has adhesiveness.

For example, the curable resin of the tow prepreg may be a thermosetting resin such as an epoxy resin, a phenol resin, an unsaturated polyester resin, a polyimide resin, or the like, but is not limited thereto.

In addition, for example, the reinforcing fiber may be a carbon fiber, a glass fiber, an aramid fiber, boron fiber, an alumina fiber, a silicon carbide fiber, or the like, but is not limited thereto.

As shown in FIG. 2, the reinforcing layer 4 is composed of a plurality of unit layers 7 laminated on the outer surface of the liner 2. The reinforcing layer 4 of this embodiment is composed of nine unit layers 7 in the body portion 5 of the liner 2, but the number of the unit layers 7 is not limited to this.

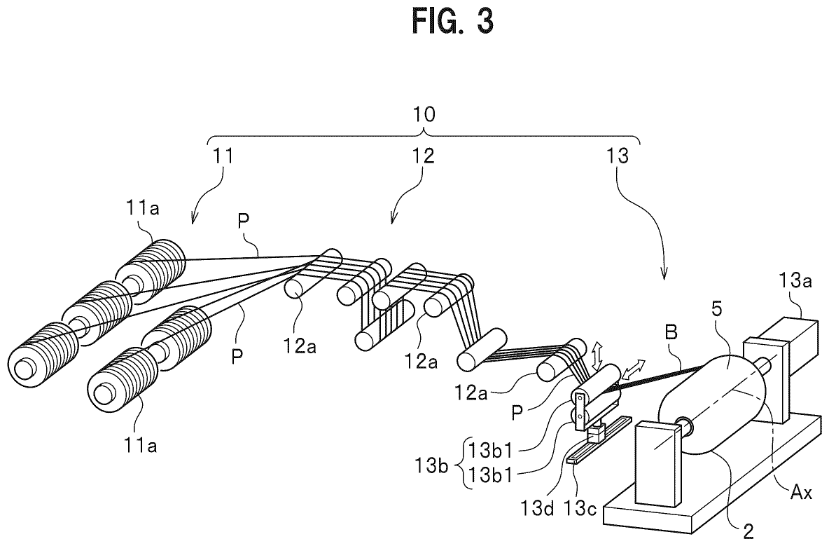

The unit layer 7 is formed by arranging bands B (see FIG. 3), which are band-shaped fiber bundles fed from a band feeding head 13b in a manufacturing equipment 10 (see FIG. 3) described later, in parallel in the axial direction of the liner 2 (the direction perpendicular to the paper surface of FIG. 2).

These unit layers 7 are integrated in a reinforcing layer forming process in which the curable resin of the tow prepreg is cured. The reinforcing layer forming process will be described later.

Next, the manufacturing equipment 10 of the high pressure tank 1 will be described.

FIG. 3 is a configuration diagram of the manufacturing equipment 10.

As shown in FIG. 3, the manufacturing equipment 10 includes a feeding mechanism 11 for feeding the tow prepreg P, a guiding mechanism 12 for guiding the tow prepreg P fed from the feeding mechanism 11 to a winding mechanism 13, and the winding mechanism 13 for winding the tow prepreg P guided by the guiding mechanism 12 around the liner 2.

The feeding mechanism 11 includes a plurality of bobbin shafts 11a around which the tow prepreg P is traverse wound, and a bobbin shaft motor (not shown) that assists rotation of the bobbin shafts 11a so that the tow prepreg P is pulled out from each bobbin shaft 11a at a predetermined tension. In the feeding mechanism 11 of this embodiment, the number of bobbin 11a is five. However, the number of the bobbin 11a is not limited to this. The number of bobbin 11a can be changed as required.

The guiding mechanism 12 includes a plurality of guiding rollers 12a over which the tow prepreg P is stretched. The guiding roller 12a has a plurality of guiding circumferential grooves (not shown) to individually guide the plurality of tow prepreg P fed from the feeding mechanism 11. These guiding circumferential grooves have a flat bottom face with a predetermined width. The tow prepreg P travels from the feeding mechanism 11 on the upstream side to the winding mechanism 13 on the downstream side while abutting against the bottom faces of the guiding circumferential grooves. As a result, the cross-sectional shape of the tow prepreg P is gradually flattened.

Each guiding roller 12a of this embodiment guides a plurality of (five) tow prepreg P fed from the feeding mechanism 11 in a lump. However, the guiding roller 12a may be configured by a divided roller that individually guides the plurality of tow prepregs P. In addition, the guiding mechanism 12 of this embodiment has seven guiding rollers 12a, but the number of guiding rollers 12a is not limited thereto.

The winding mechanism 13 includes a driving portion 13a (rotating motor) that rotates the liner 2 around the Ax-axis and a band feeding head 13b that feeds the band B to the rotating liner 2.

The band feeding head 13b arranges a plurality of (five) tow prepregs P flattened by the guiding mechanism 12 in the widthwise direction and integrates them. As a result, the band feeding head 13b forms a band B which is a band-shaped tow prepreg P.

The band feeding head 13b is composed of a pair of compressing rollers 13b1 and 13b1 arranged in parallel with a predetermined clearance therebetween. The plurality of (five) tow prepregs P arranged side by side on the upstream side of the band feeding head 13b are press-formed into the widened band B when passing between the pair of compressing rollers 13b1 and 13bl.

The band feeding head 13b can move in the Ax-axis direction of the liner 2 while feeding the band B to the rotating liner 2. Specifically, the band feeding head 13b moves in the Ax-axis direction in accordance with the rotation of the liner 2 so that the unit layer 7 (see FIG. 2) is formed on the outer circumferential side of the liner 2. The moving means of the band feeding head 13b of this embodiment is a linear actuator 13c such as a pneumatic cylinder or a linear motor, but is not limited thereto.

The band feeding head 13b is configured to adjust the tension of the band B to be fed to the liner 2. Specifically, the band feeding head 13b adjusts a load applied to the tow prepreg P in a direction intersecting the travel direction of the tow prepreg P. The tension adjustment means of the band B of this embodiment is a spacing adjustment actuator 13c provided between the linear actuator 13b and the band feeding head 13d. The spacing adjustment actuator 13d may be a rack-and-pinion mechanism or a pneumatic cylinder driven by a rotating motor, but is not limited thereto.

Further, the spacing adjustment actuator 13d of this embodiment displaces the band feeding head 13b based on the detected tension of the tow prepreg P or the band B so that the detected tension becomes a preset target tension. The means for detecting the tension of the tow prepreg P or the band B is a sensor for detecting the reaction force that the band feeding head 13b receives from the tow prepreg P or the band B, but is not limited thereto.

The displacement control means of the band feeding head 13b includes a program for instructing the spacing adjustment actuator 13d to set the detected tension of the tow prepreg P or the band B to the target tension, a read only memory (ROM) for storing the program, a random access memory (RAM) for reading and developing the program stored in the ROM, and a central processing unit (CPU) for executing the developed program and outputting an instruction to the spacing adjustment actuator 13d.

Next, a method for manufacturing the high pressure tank 1 of this embodiment will be described.

The method according to this embodiment includes a winding process of winding the band B (see FIG. 3) in which the tow prepreg P (see FIG. 3) is formed in a band shape on the outer surface of the liner 2 (see FIG. 3), and a reinforcing layer forming process of forming the reinforcing layer 4 (see FIG. 2) by curing the curable resin included in the tow prepreg P wound around the outer surface of the liner 2.

Here, the method according to this embodiment will be described in detail by taking as an example a method of winding the band B (see FIG. 3) around the body portion 5 (see FIG. 3) of the liner 2 (see FIG. 3) by a hoop winding.

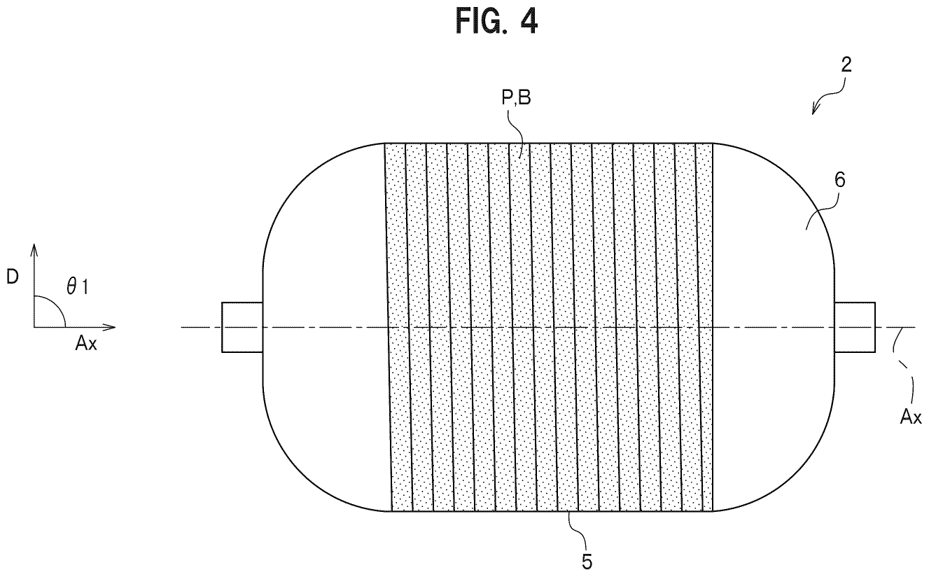

FIG. 4 is an explanatory diagram of the hoop winding of band B around the liner 2.

As shown in FIG. 4, the hoop winding is a method in which the band B is wound in a hoop shape (in a ring shape) around the body portion 5 of the liner 2. That is, the hoop winding is set so that an angle θ1 formed by the extended direction D of the band B with respect to the Ax-axis direction is close to 90 degrees so that the band B is parallel to the Ax-axis direction. As a result, the band B forms a unit layer 7 (see FIG. 2) having a thickness substantially equal to the thickness of the band B on the outer circumference of the body portion 5 of the liner 2.

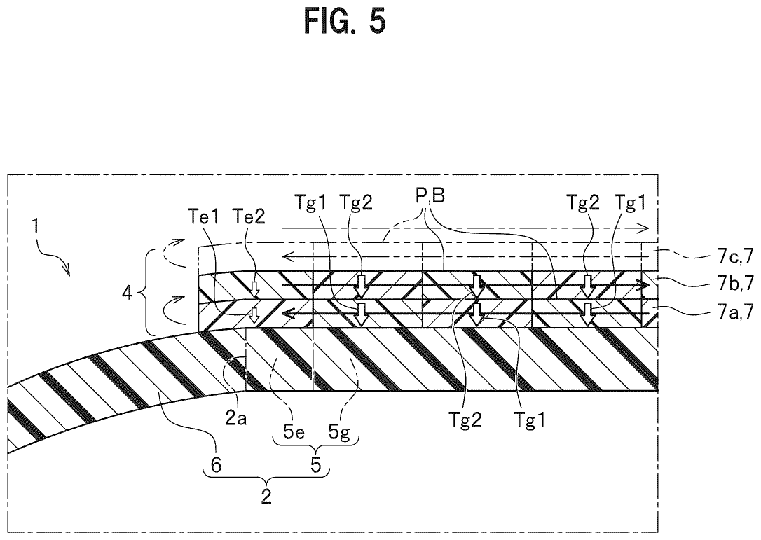

FIG. 5 is an explanatory diagram of the winding process of band B by the hoop winding. FIG. 5 is a partially enlarged sectional view of a portion V in FIG. 1. In addition, in FIG. 5, tensions Te1, Te2, Tg1, and Ts2 of the band B are indicated by white arrows pointing downward on the paper for convenience of drawing.

As shown in FIG. 5, in this winding process, a plurality of unit layers 7 are formed on the outer circumference of the body portion 5 of the liner 2. As shown in FIG. 3, in the hoop winding, the band feeding head 13b is reciprocated with respect to the rotating liner 2 by a distance corresponding to the body portion 5 of the liner 2, thereby forming the unit layer 7. Specifically, the odd-numbered unit layer 7 (see FIG. 5) is formed in the forward path of the band feeding head 13b (see FIG. 3), and the even-numbered unit layer 7 (see FIG. 5) is formed in the backward path. Thus, as shown in FIG. 5, a first unit layer 7a, a second unit layer 7b, and a third unit layer 7c are formed on the outer circumference of the body portion 5 in order from the liner 2 side. In addition, the unit layers are laminated on the top surface of the third unit layer 7c (now shown).

In addition, such a winding process is performed so that the tension of a band B (fiber bundle) at both end portions 5e of the body portion 5 of the liner 2 (in FIG. 5, only the end portion 5e on the left side of the paper surface is shown, and the end portion on the right side of the paper surface is omitted) is lower than the tension of the fiber bundle at a general portion 5g of the body portion 5.

In this embodiment, the end portion 5e of the body portion 5 is a portion adjacent to the dome portion 6. In addition, the general portion 5g of the body portion 5 is a portion that occupies almost most of the body portion 5 defined between both end portions 5e of the body portion 5.

In addition, the plurality of unit layers 7a, 7b, 7c, . . . laminated on the outer circumference of the body portion 5 of the liner 2 are independent of each other. The tensions of the bands B (fiber bundles) at the both end portions 5e are reduced to be lower than the tension of the band B (fiber bundle) at the general portion 5g.

That is, in the first unit layer 7a shown in FIG. 5, a tension Te1 of the band B (fiber bundle) wound around the end portion 5e is reduced to be lower than a tension Tg1 of the band B (fiber bundle) would around the general portion 5g. In addition, in the second unit layer 7b shown in FIG. 5, a tension Te2 of the band B (fiber bundle) wound around the end portion 5e independently of the first unit layer 7a is reduced to be lower than a tension Tg2 of the band B (fiber bundle) wound around the general portion 5g.

As shown in FIG. 5, at least a part of the band B (fiber bundle) may be wound around the end portion 5e of the body portion 5. That is, the band B (fiber bundle) may be wound around a connecting portion 2a between the body portion 5 and the dome portion 6. In addition, the loop-wound band B (fiber bundle) may be wound around the end portion 5e so as not to extend toward the dome portion 6 (not shown).

In addition, as shown in FIG. 5, the tensions of the bands B (fiber bundles) of the plurality of unit layers 7a, 7b, 7c, . . . laminated on the general portion 5g of the body portion 5 in the radial direction are preferably reduced toward the outer circumferential side.

That is, in the configuration shown in FIG. 5, the tension Tg2 of the second unit layer 7b is preferably reduced to be lower than the tension Tg1 of the first unit layer 7a (Tg1>Tg2). In addition, the tension Te1 of the end portion 5e of the first unit layer 7a is preferably reduced to be lower than the tension Tg2 of the general portion 5g of the second unit layer 7b (Te1<Tg2).

Note that the plurality of unit layers 7a, 7b, 7c, . . . are independent of each other. The tensions of the bands B (fiber bundles) at the both end portions 5e are reduced to be lower than the tension of the band B (fiber bundle) at the general portion 5g. Therefore, the configuration which meets the conditions of Tg1>Tg2 and Te1>Tg2 is acceptable.

In addition, the tensions of the bands B (fiber bundles) of the plurality of unit layers 7a, 7b, 7c, . . . laminated on the end portion 5e of the body portion 5 in the radial direction are preferably reduced toward the outer circumferential side.

That is, in the configuration shown in FIG. 5, the tension Te2 of the second unit layer 7b is preferably reduced to be lower than the tension Te1 of the first unit layer 7a (Te1>Te2).

As shown in FIG. 4, in the method of this embodiment, after the band B (see FIG. 3) is wound around the body portion 5 of the liner 2 by the hoop winding, the band B (see FIG. 3) is further wound around the liner 2 (see FIG. 3) by the helical winding. Specifically, in this method, the band B is wound by a high helical winding around the band B (see FIG. 4) wound around the body portion 5 by the hoop winding, and the band B is further wound by a low helical winding around the band B wound by the high helical winding.

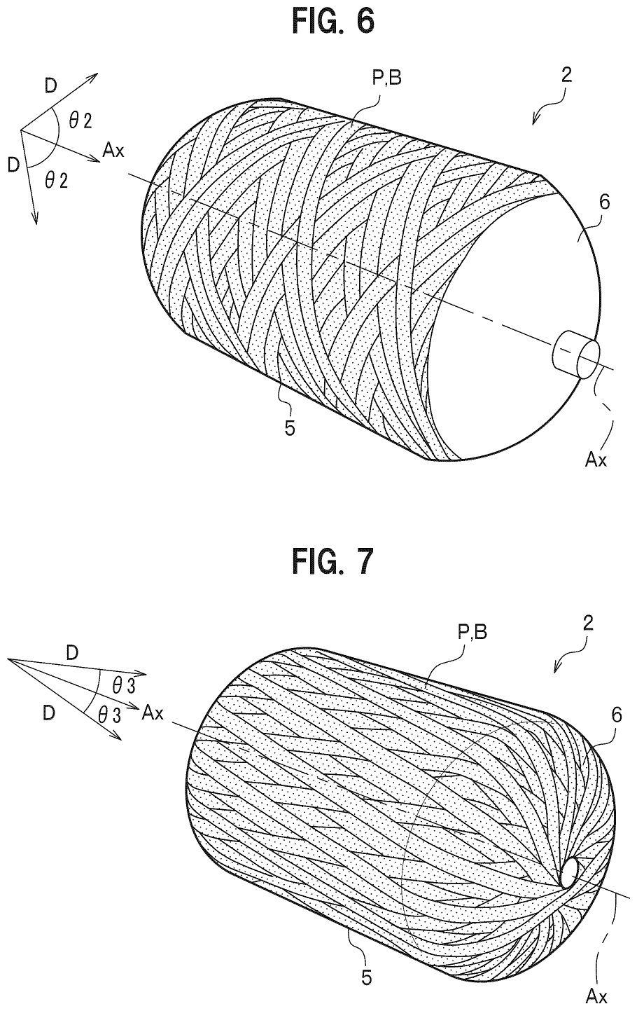

FIG. 6 is an explanatory diagram of the high helical winding of the band B (see FIG. 3). FIG. 7 is an explanatory diagram of the low helical winding of the band B (see FIG. 3).

As shown in FIG. 6, the high helical winding is set so that an angle θ2 formed by the extended direction D of the band B (see FIG. 3) with respect to the Ax-axis direction is approximately 75 degrees. As a result, the band B is wound around the body portion 5 of the liner 2 on which the hoop winding is performed and the peripheral portion of the dome portion 6 adjacent to the body portion 5.

As shown in FIG. 7, the low helical winding is set so that an angle θ3 formed by the extended direction D of the band B (see FIG. 3) with respect to the Ax-axis direction is approximately 10 degrees. As a result, the band B is wound around the entire region from the body portion 5 to the dome portion 6 of the liner 2 around which the hoop winding and the high helical winding have been performed.

In the method according to this embodiment, the tension of the band B (see FIG. 3) of the high helical winding and the tension of the band B (see FIG. 3) of the low helical winding are set to be substantially the same as the tension of the outermost band B (see FIG. 3) wound around the general portion 5g (see FIG. 5) by the hoop-winding. However, the tension of the band B (see FIG. 3) of the high helical winding and the tension of the band B (see FIG. 3) of the low helical winding can be set to be reduced toward the outer peripheral side of the reinforcing layer 4 (see FIG. 1).

In the reinforcing layer forming process, the liner 2 (see FIG. 3) which has completed the winding process is removed from the winding mechanism 13 (see FIG. 3) and is heated at a predetermined temperature in a heating furnace (not shown).

As a result, the curable resin contained in the band B (see FIG. 3) wound around the liner 2 is cured. In the process of curing the curable resin, the plurality of unit layers 7 (see FIG. 5) laminated on each other are integrated and are in close contact with the outer surface of the liner 2. Thus, the reinforcing layer 4 (see FIG. 1) is formed, and a series of manufacturing processes of the high pressure tank 1 is completed.

### Effects

Next, the operation and effect of the method for manufacturing the high pressure tank 1 of this embodiment will be described.

In the method according to this embodiment, the winding process of the band B (fiber bundle) around the liner 2 is performed so that the tension of the bands B (fiber bundles) at the both end portions 5e (see FIG. 5) of the body portion 5 is reduced to be lower than the tension of the band B (fiber bundle) at the general portion 5g (see FIG. 5) of the body portion 5.

According to this method, when the band B (fiber bundle) is wound and overlapped on the entire body portion 5 along the Ax-axis direction of the body portion 5 of the liner 2, the winding of the band B (fiber bundle) can be more reliably prevented from collapsing at the both end portions 5e of the body portion 5.

Thus, the method according to this embodiment can more reliably increase the breaking strength of the reinforcing layer 4 as compared with the prior art method (for example, see Patent Literature 1).

In addition, the winding process of this method is performed by the hoop winding of the band B (fiber bundle) around the body portion 5 of the liner 2.

According to this method, the tensions of the band B (fiber bundle) at both end portions 5e (see FIG. 5) can be more reliably reduced.

In addition, in this method, the unit layer 7 (see FIG. 2) which forms the reinforcing layer 4 (see FIG. 2) is formed by arranging the band-shaped band B (fiber bundle) in parallel in the Ax-axis direction of the liner 2.

According to this method, the tension of the band B (fiber bundle) at each of the unit layers 7 can be more reliably controlled. Thus, the difference between the tension of the band B (fiber bundle) at the general portion 5g and the tension of the band B (fiber bundle) at the end portion 5e can be equalized.

In addition, in this method, the plurality of unit layers 7 (see FIG. 5) are independent of each other. The tension of the bands B (fiber bundles) at the both end portions 5e (see FIG. 5) of the body portion 5 is reduced to be lower than the tension of the band B (fiber bundle) at the general portion 5g (see FIG. 5) of the body portion 5.

According to this method, the winding of the band B (fiber bundle) can be more reliably prevented from collapsing at the both end portions 5e (see FIG. 5) for each of the unit layers 7 (see FIG. 5).

In addition, the tensions of the bands B (fiber bundles) of the plurality of unit layers 7 laminated on the end portion 5e of the body portion 5 in the radial direction are preferably reduced toward the outer circumferential side.

According to this method, the winding of the band B (fiber bundle) can be more reliably prevented from collapsing at the both end portions 5e (see FIG. 5).

In addition, in this method, the tensions of the bands B (fiber bundles) of the plurality of unit layers 7 (see FIG. 5) laminated in the radial direction of the general portion 5g are preferably reduced toward the outer circumferential side.

According to this method, the tension of the outer layer side band B (fiber bundle) wound around the liner 2 prevents the inner layer side band B (fiber bundle) from loosening, that is, the so-called bandage effect. According to this method, the breaking strength of the reinforcing layer 4 can be more reliably increased.

Although the embodiments of the present invention have been described above, the present invention is not limited to the embodiments and can be implemented in various forms.

What is claimed is:

1. A method for manufacturing a high pressure tank having a reinforcing layer on an outer surface of a liner provided with dome portions at both end portions of a round tubular shaped body portion, the method comprising:
a winding process of winding a fiber bundle containing a curable resin and having a predetermined tension on the outer surface of the liner; and
a reinforcing layer forming process of forming the reinforcing layer by curing the curable resin contained in the fiber bundle wound around the outer surface, wherein
the winding process is performed so that the tensions of the fiber bundles at the both end portions are lower than a tension of the fiber bundle at a general portion of the body portion defined between the both end portions.

2. The method according claim 1, wherein
the winding process is performed by a hoop winding of the fiber bundle around the body portion of the liner.

3. The method according claim 1, wherein
the reinforcing layer is composed of a plurality of unit layers laminated on the outer surface of the liner, and
the unit layer is formed by arranging band-shaped fiber bundles in parallel in an axial direction of the liner.

4. The method according claim 3, wherein
the unit layers are independent of each other, and
the tensions of the fiber bundles at both end portions of the body portion are reduced to be lower than the tension of the fiber bundle at the general portion of the body portion.

5. The method according claim 4, wherein
the tensions of the fiber bundles of the plurality of unit layers laminated on the general portion of the body portion in the radial direction are reduced toward an outer circumferential side.
